(19) United States
(12) Patent Application Publication
(10) Pub. No.: US 2026/0261677 A1
(43) Pub. Date: Sep. 3, 2026

(54) ENTROPY CODING TRANSFORM COEFFICIENT SIGNS

(71) Applicant: MEDIATEK INC., Hsinchu City (TW)

(72) Inventor: Shih-Ta HSIANG, Hsinchu City (TW)

(21) Appl. No.: 18/716,357

(22) PCT Filed: Dec. 8, 2022
(86) PCT No.: PCT/CN2022/137504

§ 371 Date: Jun. 4, 2024

Related U.S. Application Data
(60) Provisional application No. 63/287,603, filed on Dec. 9, 2021.

(51) Int. Cl. H04N 19/13; H04N 19/176; H04N 19/18; H04N 19/91

(52) U.S. Cl. CPC H04N 19/13; H04N 19/176; H04N 19/18; H04N 19/91

(57) ABSTRACT

A method entropy encoding or decoding transform coefficients using sign prediction is provided. A video coder receives data to be encoded or decoded as a current block of a current picture of a video. The video coder selects a context variable for a current sign prediction residual based on an absolute value of a current transform coefficient. The current sign prediction residual is a difference between a predicted sign and a sign of the current transform coefficient of the current block. The video coder entropy encodes or decodes the current sign prediction residual using the selected context variable. The video coder reconstructs the current block by using the sign and the absolute value of the current transform coefficient.

### CROSS REFERENCE TO RELATED PATENT APPLICATION(S)

The present disclosure is part of a non-provisional application that claims the priority benefit of U.S. Provisional Patent Application No. 63/287,603, filed on 9 Dec. 2021. Contents of above-listed applications are herein incorporated by reference.

### TECHNICAL FIELD

The present disclosure relates generally to video coding. In particular, the present disclosure relates to methods of coding signs of transform coefficients.

### BACKGROUND

Unless otherwise indicated herein, approaches described in this section are not prior art to the claims listed below and are not admitted as prior art by inclusion in this section.

In video coding, the input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

Versatile video coding (VVC) is the latest international video coding standard developed by the Joint Video Expert Team (JVET) of ITU-T SG16 WP3 and ISO/IEC JTC1/SC29/WG11. In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of several split types. Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify a 2-D sample array of one color component (Y/Cb/Cr) associated with CTU, CU, PU, and TU, respectively. A CTU includes one luma CTB, two chroma CTBs, and associated syntax elements. A similar relationship is valid for CU, PU, and TU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods and systems for entropy coding transform coefficients using sign prediction. A video coder receives data to be encoded or decoded as a current block of a current picture of a video. The video coder selects a context variable for a current sign prediction residual based on an absolute value of a current transform coefficient. The current sign prediction residual is a difference between a predicted sign and a sign of the current transform coefficient of the current block. The video coder entropy encodes or decodes the current sign prediction residual using the selected context variable. The video coder reconstructs the current block by using the sign and the absolute value of the current transform coefficient.

In some embodiments, the predicted sign is one of a set of predicted signs of a best sign prediction hypothesis, with the best sign prediction hypothesis being one having a lowest cost among multiple candidate sign prediction hypotheses. The cost of a particular sign prediction hypothesis may be computed based on residuals in pixel domain that are transformed from a set of transform coefficients having the set of predicted signs of the sign prediction.

In some embodiments, the context variable is selected dependent on the absolute value of the current transform coefficient when the current transform coefficient belongs to a first set of transform coefficients, or the context variable is selected independent of the absolute value of the current transform coefficient when the current transform coefficient belongs to a second, different set of transform coefficients.

In some embodiments, the context variable is selected dependent on whether the absolute value of the current transform coefficient is greater than a particular threshold or within a particular numerical range. In some embodiments, a first context variable is selected when the transform coefficient is greater than or equal to the particular threshold and a second context variable is selected when the transform coefficient is less than the particular threshold.

In some embodiments, the selection of the context variable for the current sign prediction residual is further based on whether the current block is coded by using intra-prediction or by using inter-prediction. In some embodiments, the selection of the context variable for the current sign prediction residual is further based on whether the current transform coefficient belongs to a luma transform block or to a chroma transform block.

In some embodiments, the selection of the context variable may be based on a position of the current transform coefficient in a current transform block of the current block. In some embodiments, the selection of the context variable may be further based on at least one of (i) a dimension of the current transform block, (ii) a transform type of the current transform block, (iii) a color component index of the current transform block, (iv) a number of the predicted signs in the current transform block, (v) a number of the non-zero coefficients in the current transform block, (vi) a position of the last significant transform coefficient in the current transform block, (vii) a sum of the absolute values of transform coefficients that are subject to sign prediction, (viii) a sum of the absolute values of the transform coefficients that are subject to sign prediction after the current transform coefficient. In some embodiments, the selection of the context variable may be based on an absolute value of a next transform coefficient that is subject to sign prediction.

In some embodiments, the video coder selects the context variable based on whether the current transform coefficient is a DC coefficient. The selection of the context variable may be based on whether a predicted sign of the DC coefficient of the current block is correct.

In some embodiments, the selection of the context variable is further based on an accumulated number of incorrectly predicted signs in the current block. The video coder may encode the current sign prediction residual into the bitstream in bypass mode when an accumulated number of incorrectly predicted signs of the current block exceeds a threshold.

In some embodiments, the selection of the context variable is based on a total number of sign prediction residuals in the current transform block. In some embodiments, the selection of the context variable is further based on a distance between an origin of the current transform block and a position of the current transform coefficient in the current transform block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows a block diagram of an engine that performs a context-based adaptive binary arithmetic coding (CABAC) process.

FIG. 2 illustrates transform coefficients in a transform block.

FIG. 3 conceptually illustrates sign prediction for a collection of signs of transform coefficients.

FIG. 4 conceptually illustrates discontinuity measures across block boundaries for a current block.

FIG. 5 conceptually illustrates using cost function to select a best sign prediction hypothesis.

FIG. 6 illustrates an example video encoder that may use sign prediction when entropy coding transform coefficients.

FIG. 7 illustrates portions of the video encoder that implements sign prediction and context selection.

FIG. 8 conceptually illustrates a process for entropy encoding transform coefficients using sign prediction.

FIG. 9 illustrates an example video decoder that may use sign prediction when entropy coding transform coefficients.

FIG. 10 illustrates portions of the video decoder that implements sign prediction and context selection.

FIG. 11 conceptually illustrates a process for entropy decoding transform coefficients using sign prediction.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Sign Prediction for Context Based Coding

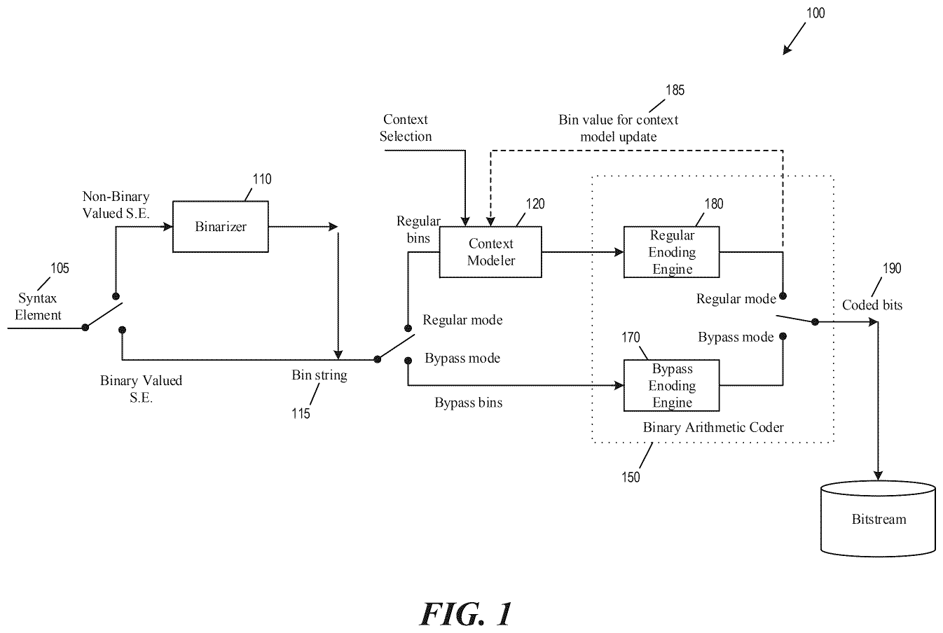

In some embodiments, for achieving higher compression efficiency in video coding, context-based adaptive binary arithmetic coding (CABAC) mode, or known as regular mode, is employed for entropy coding syntax elements of coded video. FIG. 1 shows a block diagram of an engine that performs a CABAC process.

The CABAC operation first convert the value of a syntax elements (SE) 105 into a binary string 115. This process is commonly referred to as binarization (at a binarizer 110).

The arithmetic coder 150 performs a coding process on the binary string 115 to produce coded bits 190. The coding process can be performed in regular mode (through a regular encoding engine 180) or bypass mode (through a bypass encoding engine 170).

When the regular mode is used, a context modeler 120 performs context modeling on the incoming binary string (or bins) 115 and the regular encoding engine 180 performs the coding process on the binary string 115 based on the probability models of different contexts in the context modeler 120. The coding process of the regular mode produces coded binary symbols 185, which are also used by the context modeler 120 to build or update the probability models. The selection of a modeled context (context selection) for coding the next binary symbol can be determined by the coded information. On the other hand, when bypass mode is used, symbols are coded without the context modeling stage and assume an equal probability distribution.

In some embodiments, the transform coefficients may be quantized by dependent scalar quantization. The selection of one of the two quantizers is determined by a state machine with four states. The state for a current transform coefficient is determined by the state and the parity of the absolute level value for the preceding transform coefficient in scanning order. The transform blocks are partitioned into non-overlapped sub-blocks. The transform coefficient levels in each sub-block are entropy coded using multiple sub-block coding passes. Syntax elements sig_coeff_flag, abs_level_gt1_flag, par_level_flag and abs_level_gt3_flag are all coded in the regular mode in the first sub-block coding pass. The elements abs_level_gt1_flag and abs_level_gt3_flag indicate whether the absolute value of the current coefficient level is greater than 1 and greater than 3, respectively. The syntax element par_level_flag indicates the parity bit of the absolute value of the current level. The partially reconstructed absolute value of a transform coefficient level from the 1^{st} pass is given by:

$$AbsLevelPass 1 = sig\_coeff \_flag + par\_level \_flag + abs\_level \_gt1 \_flag + 2 * abs\_level \_gt3 \_flag$$

The context selection (selection of a context variable or a probability model in the context modeler 120) for entropy coding sig_coeff_flag is dependent on the state for the current coefficient. The variable par_level_flag is thus signaled in the first coding pass for deriving the state for the next coefficient. The syntax elements abs_remainder and coeff_sign_flag are further coded in the bypass mode in the following sub-block coding passes to indicate the remaining coefficient level values and signs, respectively. The fully reconstructed absolute value of a transform coefficient level is given by

$$AbsLevel = AbsLevelPass 1 + {2}^{*} abs\_remainder \qquad ( A )$$

The transform coefficient level is given by

$$TransCoeffLevel = ( 2 * AbsLevel - ( QState > 1 ? 1 : 0 ) ) * ( 1 - 2 * coeff\_sign \_flag ) \qquad ( B )$$

where QState indicates the state for the current transform coefficient.

In some embodiments, in order to further improve coding efficiency, a collection of signs of the transform coefficients of a residual transform block are jointly predicted.

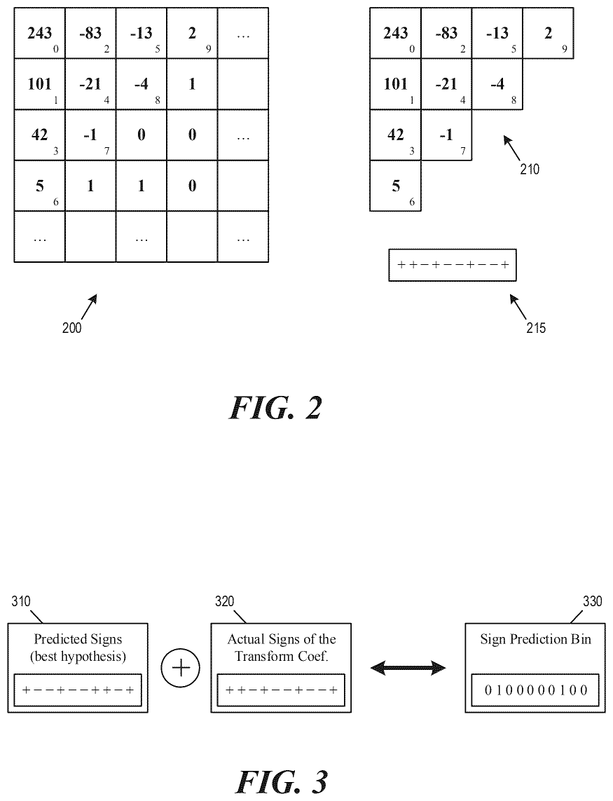

FIG. 2 illustrates transform coefficients in a transform block. The transform block 200 is an array of transform coefficients from transformed inter- or intra-prediction residuals. The transform block 200 may be one of several transform blocks of the current block being coded, which may have multiple transform blocks for different color components. The transform block includes N×N transform coefficients. One of the transform coefficients is the DC coefficient. The coefficients of the transform block 200 may be ordered and indexed in a zig-zag fashion. The transform coefficients of the current transform block 200 are signed, but only the signs of a subset 210 of the transform coefficients are jointly predicted (e.g., the first 10 non-zero coefficients) as a collection of signs 215.

FIG. 3 conceptually illustrates sign prediction for a collection of signs of transform coefficients. The figure illustrates a collection of actual signs 320 (e.g., the transform coefficient signs in the subset 210) and a corresponding collection of predicted signs 310. The actual signs 320 and the predicted signs 310 are XORed (exclusive or) together to generate sign prediction residuals 330. In the example sign prediction residuals 330, a ‘0’ represent a correctly predicted sign (i.e., the predicted 30 sign and the corresponding actual sign are the same), and a ‘1’ represent an incorrectly predicted sign (i.e., the predicted sign and the corresponding actual sign are different.) Thus, a “good” sign prediction would result in the sign prediction residuals 330 having mostly 0s, so the sign prediction residuals 330 can be coded by CABAC using fewer bits.

A sign prediction residual that is currently being processed by CABAC context modeling can be referred to as the current sign prediction residual. The transform coefficient that corresponds to the current sign prediction residual can be referred to as the current transform coefficient, and the transform block whose transform coefficients are currently process by CABAC can be referred to as the current transform block.

In some embodiments, both video encoder and video decoder determine a “best” set of predicted signs by examining different possible combinations or sets of predicted signs. Each possible combination of predicted signs is referred to as a sign prediction hypothesis. The collection of signs in the best candidate sign prediction hypothesis is used as the predicted signs 310 for generating the sign prediction residuals 330. (A video encoder uses the signs of the best hypothesis 310 and the actual signs 320 to generate the sign prediction residual 330 for CABAC. A video decoder receives sign prediction residuals 330 from inverse CABAC and uses the predicted signs 310 of the best hypothesis to reconstruct the actual signs 320.)

In some embodiments, a cost function is used to examine the different candidate sign prediction hypotheses and identify a best candidate sign prediction hypothesis. Reconstructed residuals are calculated for all candidate sign prediction hypotheses (including both negative and positive sign combinations for applicable transform coefficients.) The candidate hypothesis having the minimum (best) cost is selected for the transform block. The cost function may be defined based on discontinuity measures across block boundaries, specifically, as a sum of absolute second derivatives in the residual domain for the above row and left column.

The cost function is as follows:

$$cost = {\sum }_{x = 0}^{w - 1} \vert ( - {R}_{x , - 2} + 2 {R}_{x , - 1} - {P}_{x , 0} ) - {r}_{x , 0} \vert + {\sum }_{y = 0}^{h - 1} \vert ( - {R}_{- 2 , y} + 2 {R}_{- 1 , y} - {P}_{0 , y} ) - {r}_{0 , y} \vert \qquad ( 1 )$$

where R is reconstructed neighbors, P is prediction of the current block, and r is the prediction residual of the hypothesis being tested. The cost function is measured for all candidate sign prediction hypotheses, and the candidate hypothesis with the smallest cost is selected as a predictor for coefficient signs (predicted signs).

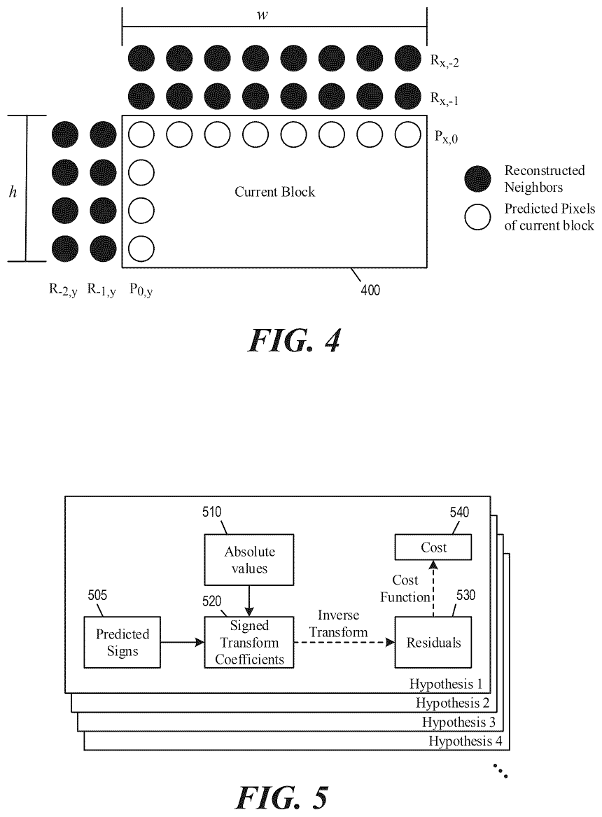

FIG. 4 conceptually illustrates discontinuity measures across block boundaries for a current block 400. The figure shows the pixel positions of the reconstructed neighbors R_{x,-2}, R_{x,-1}, R_{-2,y}, R_{-1,y} above and to the left of the current block and predicted pixels P_{x,0}, P_{0,y} of the current block that are along the top and left boundaries. The positions of P_{x,0}, P_{0,y} are also that of the prediction residuals r_{x,0}, r_{0,y} of a sign prediction hypothesis. The predicted pixels P_{x,0}, P_{0,y} may be provided by a motion vector and a reference block. The prediction residuals r_{x,0}, r_{0,y} are obtained by inverse transform of the coefficients, with each coefficient having a predicted sign provided by the sign prediction hypothesis. The values of R_{x,-2}, R_{x,-1}, R_{-2,y}, R_{-1,y}, P_{x,0}, P_{0,y} and r_{x,0}, r_{0,y} are used to calculate a discontinuity measure across the block boundaries for the current block 400 according to Eqn (1), which is used as a cost function to evaluate each candidate sign prediction hypothesis.

FIG. 5 conceptually illustrates using cost function to select a best sign prediction hypothesis. The figure illustrates multiple sign prediction hypotheses (hypothesis 1, 2, 3, 4, . . . ) being evaluated for the current block. Each sign prediction hypothesis has a different collection of predicted signs for the transform coefficients of the current block 400.

To evaluate the cost of a candidate sign prediction hypothesis, the absolute values 510 (of the transform coefficients of a current transform block) are paired with predicted signs 505 of the candidate hypothesis to become signed transform coefficients 520. The signed transform coefficients 520 are inverse transformed to become residuals 530 of the hypothesis in the pixel domain. The residuals at the boundary of the current block (i.e., r_{x,0}, r_{0,y}) are used by the cost function (Eqn. 1) to determine the cost 540 of the candidate hypothesis. The candidate hypothesis with the lowest cost is then selected as the best sign prediction hypothesis.

In some embodiments, only signs of coefficients from the top-left 4×4 transform subblock region (with lowest frequency coefficients in the transform domain) in a transform block are allowed to be included into a hypothesis. In some embodiments, the maximum number of the predicted signs Nₛₚ that can be included in each sign prediction hypothesis of a transform block is signaled in the sequence parameter set (SPS). In some embodiments, this maximum number is constrained to be less than or equal to 8. The signs of first Nₛₚ non-zero coefficients (if available) are collected and coded according to a raster-scan order over the top-left 4×4 subblock.

For each of those coefficients (coefficients whose signs are predicted), instead of the coefficient sign, a sign prediction residual is signaled to indicate whether the coefficient sign is equal to the sign predicted by the selected hypothesis. In some embodiments, the sign prediction residual is context coded, where the selected context is derived from whether a coefficient is DC or not. In some embodiments, the contexts are separated for intra and inter blocks, for luma and chroma components. For those other coefficients without sign prediction, the corresponding signs are coded by CABAC in the bypass mode.

### II. Context Selection for Sign Prediction

In some embodiments of the disclosure, a modified method related to entropy coding the signs of the transform coefficient levels in an image or video coding system is provided. A collection of signs of transform coefficients in a transform block are predicted based on a cost function related to discontinuity measure on pixel sample values across block boundaries. Eqn. (1) is an example of such a cost function. Efficiency of entropy coding is further improved by more effectively exploiting contextual information for context modeling for encoding or decoding the syntax elements related to the predicted signs of transform coefficient levels.

In some embodiments, context modeling for entropy coding the sign prediction residual of a current transform coefficient may be conditioned on information about the absolute value of the current transform coefficient level. This is because the coefficients with larger absolute level values have higher impacts on the output values of the cost function and therefore tend to have higher correct prediction rate. The context modeling of the sign prediction residual may also be condition upon other information about the current transform block or other transform coefficients of the current transform block.

In some embodiments, a video coder employs multiple context variables for coding syntax information related to the signs of the transform coefficient levels associated with sign prediction. The selection of a context variable for coding the sign of a current coefficient level may further depend on the absolute value of the current transform coefficient level. In some embodiments, context selection for entropy coding sign prediction residuals of certain coefficients is further dependent on whether the absolute value of the current transform coefficient level is greater or less than one or more thresholds. For example, context selection for entropy coding the sign prediction residuals of certain coefficients is further dependent on whether the absolute value of the current transform coefficient level is greater than a first threshold T1. In some preferred embodiments, the first threshold T1 can be equal to 1, 2, 3, or 4. In another example, the context selection for entropy coding the sign prediction residuals of certain coefficients is further dependent on whether the absolute value of the current transform coefficient level is greater than a second threshold T2, wherein T2 is greater than the first threshold T1. In some preferred embodiments, (T1, T2) can be equal to (1, 2), (1, 3), or (2, 4).

In some embodiments, a video coder may further set the values of the one or more thresholds (e.g., T1, T2) adaptively considering the coding context for the current transform block. In some embodiments, the derivation of the one or more thresholds may further depend on the transform block dimension, transform type, color component index, number of the predicted signs, number of the non-zero coefficients, or position of the last significant coefficient associated with the current transform block. The derivation of the one or more thresholds may further depend on the prediction mode of the current CU. The derivation of the one or more thresholds may further depend on the position or index associated with a current coefficient in a transform block. The derivation of the one or more thresholds may further depend on the sum of the absolute values of the coefficients subject to sign prediction in the current transform block.

In some embodiments, context modeling for entropy coding the sign prediction residual of a current coefficient may be further conditioned on derived information from the absolute values of the current coefficient level and other coefficient levels in a current transform block. In some embodiments, the context selection for entropy coding the sign of a coefficient in a current transform block may be further dependent on the sum of the absolute values of the coefficients subject to sign prediction in the current transform block. In some embodiments, the context selection for entropy coding the sign of a coefficient in a current transform block may be further dependent on the absolute value of the next coefficient subject to sign prediction or the sum of the absolute values of the remaining coefficients subject to sign prediction in the current transform block.

In some embodiments, the context selection based on the absolute coefficient level may only be employed by a specified set of transform coefficients. The context selection for a current coefficient is independent of the absolute coefficient level when the current coefficient does not belong to the specified set of transform coefficients. In some embodiments, the specified set of transform coefficients are the first N1 coefficients associated with sign prediction according to a pre-defined scan order in a transform block. The context selection is independent on the absolute coefficient level when a current coefficient does not belong to the first N1 coefficients. In some preferred embodiments, the pre-defined order is the order for entropy coding the sign prediction residuals. In some embodiments, N1 is equal to 1, 2, 3, or 4. In some embodiments, the specified set of transform coefficients correspond to the coefficients from a transform coefficient region or scan index range. In some preferred embodiments, the specified set of transform coefficients correspond to a DC coefficient in a transform block. The context selection for sign coding may depend on the absolute value of a current transform coefficient level when a current transform coefficient is a DC coefficient. The context selection for sign coding is independent on the absolute value of a current transform coefficient level, otherwise. In some embodiments, the specified set of transform coefficients are from luma blocks only. The context selection for sign coding may be dependent on the absolute value of a current transform coefficient level in a luma TB and is independent on the absolute value of a current transform coefficient level in a chroma TB. In some specific embodiments, the specified set of transform coefficients are only associated with some particular transform block dimensions, transform types, or CU coding modes.

In some embodiments, context modeling for entropy coding the sign prediction residual of a current coefficient may be further conditioned on information about the coded sign prediction residuals in the current transform block. In some embodiments, the context selection for entropy coding the sign prediction residuals of certain coefficients may further depend on whether the first coded sign prediction or the DC sign prediction for the current transform block is correct. In some embodiments, the context selection for entropy coding the sign of a current coefficient may further depend on the accumulated number of the sign prediction residuals corresponding to incorrect sign prediction. In some specific embodiment, the context selection for entropy coding the sign prediction residuals of certain coefficients is dependent on whether the accumulated number of the sign prediction residuals corresponding to incorrect sign prediction is greater than one or more specified threshold values. In one preferred embodiment, context selection for entropy coding the sign prediction residuals of certain coefficients is dependent on whether the accumulated number of the sign prediction residuals corresponding to incorrect sign prediction is greater than T_{ic}, wherein T_{ic} is equal to 0, 1, 2 or 3. In some embodiments, entropy coding the remaining sign prediction residuals may be switched to the bypass mode when the accumulated number of the coded sign prediction residuals corresponding to incorrect sign prediction is greater than a specified threshold.

In some embodiments, context modeling for entropy coding the sign prediction residual of a current transform coefficient may be further conditioned on the total number of the sign prediction residuals in the current transform block. In some embodiments, the context selection for entropy coding the sign prediction residuals of certain coefficients in a current transform block may be further dependent on whether the total number of the sign prediction residuals in the current transform block is greater than one or more non-zero threshold values. In some of these embodiments, the video coder may further set the values of the one or more thresholds adaptively based on the coding context for the current transform block. In some embodiments, the video coder my derive the one or more thresholds based on the transform block dimension, transform type, color component index, position of the last significant coefficient, or number of the non-zero coefficients associated with the current transform block. The derivation of the one or more thresholds may further depend on the prediction mode of the current CU. The derivation of the one or more thresholds may further depend on the absolute level, position or index associated with a current coefficient in a transform block. The derivation of the one or more thresholds may further depend on the sum of the absolute values of the coefficients subject to sign prediction in the current transform block.

In some embodiments, context modeling for entropy coding the sign prediction residual of a current coefficient may be further conditioned on information about the index or the position of the current transform coefficient in a transform block, wherein the index of the current transform coefficient may correspond to the scan order for coding predicted signs, or may be derived according to a raster-scan order, a diagonal scan order (as shown in FIG. 2), or the sorted order related to the absolute value of the coefficient levels in the current transform block. In some embodiments, the context selection for entropy coding the sign prediction residuals of certain coefficients is dependent on whether the index of the current transform coefficient level is greater or less than one or more non-zero threshold values.

In some other embodiments, the context selection for entropy coding the sign prediction residuals of certain coefficients is dependent on whether the distance between the top-left block origin at position (0, 0) and the current coefficient position (x, y) equal to x+y is greater or less than another one or more non-zero threshold values. In some embodiments, the video coder may set the values of the said one or more thresholds or another one or more non-zero thresholds adaptively considering the coding context for the current transform block. In some embodiments, the derivation of the said one or more thresholds or another one or more non-zero threshold may further depend on the transform block dimension, transform type, color component index, number of the predicted signs, number of the non-zero coefficients, or position of the last significant coefficient associated with the current transform block. The derivation of the said one or more thresholds or another one or more non-zero threshold may further depend on the prediction mode of the current CU. The derivation of the one or more thresholds may further depend on the absolute level associated with the current coefficient or further depend on the sum of the absolute values of the coefficients subject to sign prediction in the current transform block.

In some embodiments, context modeling for entropy coding the sign prediction residual of a current coefficient in a current transform block may be further conditioned on the width, height or block size of the current transform block. In some embodiments, the context selection for entropy coding the sign prediction residuals of certain coefficients in a current transform block is dependent on whether the width, height or block size of the current transform block is greater or less than one or more threshold values.

According to another aspect of the present invention, context modeling for entropy coding the sign prediction residual of a current coefficient in a current transform block may be further conditioned on the transform type associated with the current transform block. In some embodiments, the context selection for entropy coding the sign prediction residuals of certain coefficients in a current transform block may further depend on the transform type associated with the current transform block. In some exemplary embodiment, a video coder may assign a separate set of contexts for entropy coding the sign prediction residuals of certain transform coefficients in a current transform block when the current block transform type belongs to low-frequency non-separable transform (LFNST) or multiple transform selection (MTS).

In some embodiments, entropy coding the sign of a current coefficient may refer to entropy coding the sign prediction residual of a current coefficient in any of the proposed methods. When dependent scalar quantization is enabled, the transform coefficient levels in any of the proposed methods may refer to the transform coefficient levels before the level mapping given by Eqns. (A) or after the level mapping given by (B). The proposed aspects, methods and related embodiments can be implemented individually and jointly in an image and video coding system.

Any of the foregoing proposed methods can be implemented in encoders and/or decoders. For example, any of the proposed methods can be implemented in a coefficient coding module of an encoder, and/or a coefficient coding module of a decoder. Alternatively, any of the proposed methods can be implemented as a circuit integrated to the coefficient coding module of the encoder and/or the coefficient coding module of the decoder.

### III. Example Video Encoder

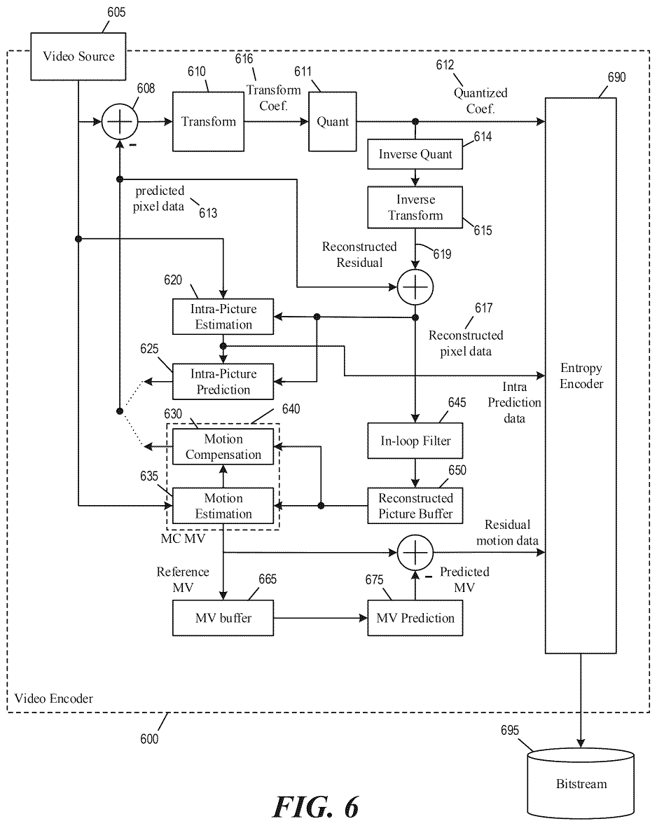

FIG. 6 illustrates an example video encoder 600 that may use sign prediction when entropy coding transform coefficients. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering operation performed includes sample adaptive offset (SAO). In some embodiment, the filtering operations include adaptive loop filter (ALF).

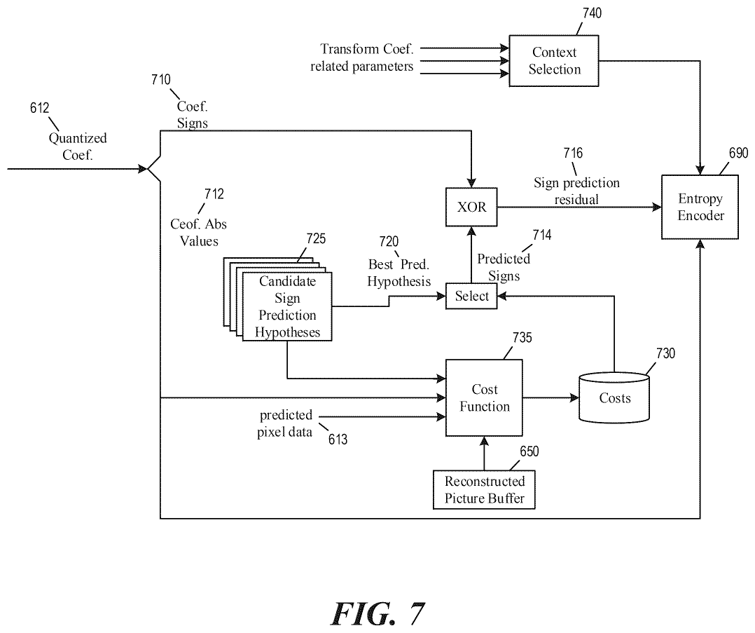

FIG. 7 illustrates portions of the video encoder 600 that implements sign prediction and context selection. As illustrated, the quantized coefficients 612 includes coefficient signs 710 and coefficient absolute values 712 components. The coefficient signs 710 (or the actual signs) are XOR′ed with predicted signs 714 to generate sign prediction residuals 716. The predicted signs 714 are provided by a best prediction hypothesis 720, which is selected from multiple possible different sign prediction hypotheses 725 based on costs 730. The costs 730 are computed by a cost function 735 for different candidate sign prediction hypotheses 725. For each candidate sign prediction hypothesis, the cost function 735 uses (i) pixel values provided by the reconstructed picture buffer 650, (ii) the absolute values 712 of transform coefficients, and (iii) the predicted pixel data 613 to compute a cost. In some embodiments, the cost of a particular sign prediction hypothesis may be computed based on residuals in pixel domain that are transformed from a set of transform coefficients having the set of predicted signs of the sign prediction. An example of the cost function is provided by Eqn. (1) and described by reference to FIG. 5 above.

The sign prediction residuals 716 are provided to the entropy encoder 690 and coded by the CABAC process. A block diagram of the CABAC process is described by reference FIG. 1 above. The sign prediction residuals 716 are coded in the regular mode using one or more context variables or probability models. The context selection (at a context selection module 740) is based on one or more parameters related to the transform coefficients. The selection of the context variables is described in greater detail in Section II above. The parameters used for the context selection are provided by components of the video encoder 600, or other components such as a rate-distortion controller.

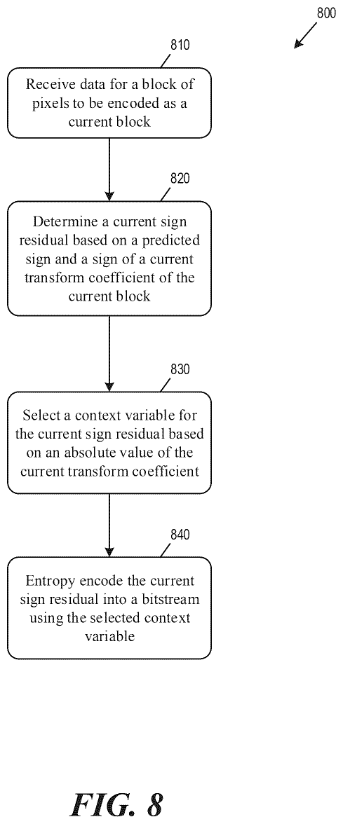

FIG. 8 conceptually illustrates a process 800 for entropy encoding transform coefficients using sign prediction. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder receives (at block 810) data to be encoded as a current block of pixels in a current picture.

The encoder determines (at block 820) a current sign prediction residual based on a predicted sign and a sign of a current transform coefficient of the current block. In some embodiments, the current sign prediction residual is a difference between a predicted sign and a sign of the current transform coefficient of the current block. In some embodiments, the predicted sign is one of a set of predicted signs of a best sign prediction hypothesis, with the best sign prediction hypothesis being one having a lowest cost among multiple candidate sign prediction hypotheses. The cost of a particular sign prediction hypothesis may be computed based on residuals in pixel domain that are transformed from a set of transform coefficients having the set of predicted signs of the sign prediction hypothesis (e.g., according to Eqn. 1).

The encoder selects (at block 830) a context variable for the current sign prediction residual based on an absolute value of the current transform coefficient. The selection of the context variables is described in greater detail in Section II above.

In some embodiments, the context variable is selected dependent on the absolute value of the current transform coefficient when the current transform coefficient belongs to a first set of transform coefficients, or the context variable is selected independent of the absolute value of the current transform coefficient when the current transform coefficient belongs to a second, different set of transform coefficients.

In some embodiments, the context variable is selected dependent on whether the absolute value of the current transform coefficient is greater than a particular threshold or within a particular numerical range. In some embodiments, a first context variable is selected when the transform coefficient is greater than or equal to the particular threshold and a second context variable is selected when the transform coefficient is less than the particular threshold.

In some embodiments, the selection of the context variable for the current sign prediction residual is further based on whether the current block is coded by using intra-prediction or by using inter-prediction. In some embodiments, the selection of the context variable for the current sign prediction residual is further based on whether the current transform coefficient belongs to a luma transform block or to a chroma transform block. For example, the encoder may select a first subset of context variables for the current sign prediction residual when the current block is coded by using intra-prediction and a second subset of context variables when the current block is coded by using inter-prediction. The encoder may select a first set of context variables for the current sign prediction residual when the current transform coefficient belongs to a luma transform block and a second set of context variables when the current transform coefficient belongs to a chroma transform block.

In some embodiments, the selection of the context variable may be based on a position of the current transform coefficient in a current transform block of the current block. In some embodiments, the selection of the context variable may be further based on at least one of (i) a dimension of the current transform block, (ii) a transform type of the current transform block, (iii) a color component index of the current transform block, (iv) a number of the predicted signs in the current transform block, (v) a number of the non-zero coefficients in the current transform block, (vi) a position of the last significant transform coefficient in the current transform block, (vii) a sum of the absolute values of transform coefficients that are subject to sign prediction, (viii) a sum of the absolute values of the transform coefficients that are subject to sign prediction after the current transform coefficient. In some embodiments, the selection of the context variable may be based on an absolute value of a next transform coefficient that is subject to sign prediction.

In some embodiments, the encoder selects the context variable based on whether the current transform coefficient is a DC coefficient. The selection of the context variable may be based on whether a predicted sign of the DC coefficient of the current block is correct.

In some embodiments, the selection of the context variable is further based on an accumulated number of incorrectly predicted signs in the current block. The encoder may encode the current sign prediction residual into the bitstream in bypass mode when an accumulated number of incorrectly predicted signs of the current block exceeds a threshold.

In some embodiments, the selection of the context variable is based on a total number of sign prediction residuals in the current transform block. In some embodiments, the selection of the context variable is further based on a distance between an origin of the current transform block and a position of the current transform coefficient in the current transform block.

The encoder entropy encodes (at block 840) the current sign prediction residual into a bitstream using the selected context variable.

### IV. Example Video Decoder

In some embodiments, an encoder may signal (or generate) one or more syntax element in a bitstream, such that a decoder may parse said one or more syntax element from the bitstream.

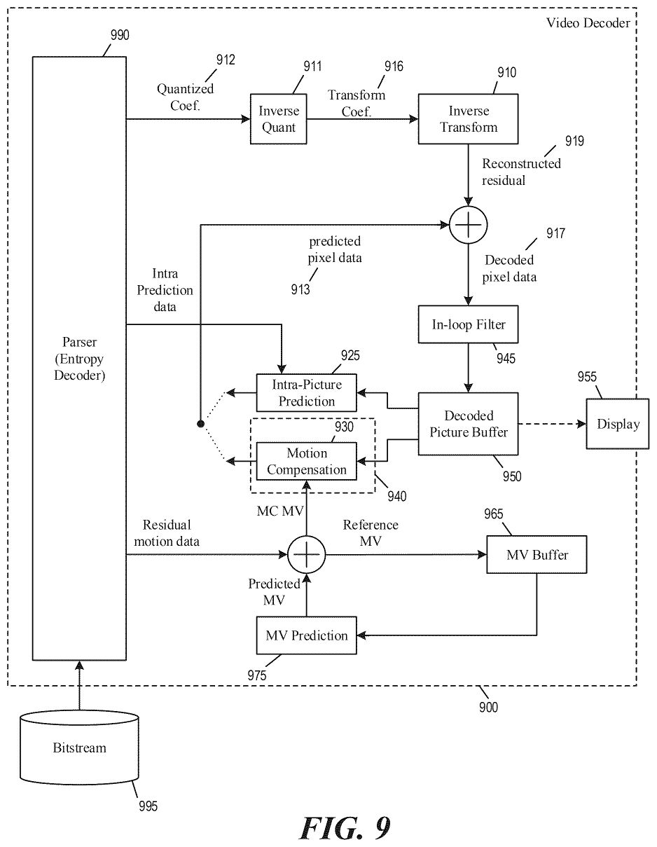

FIG. 9 illustrates an example video decoder 900 that may use sign prediction when entropy coding transform coefficients. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering operation performed includes sample adaptive offset (SAO). In some embodiment, the filtering operations include adaptive loop filter (ALF).

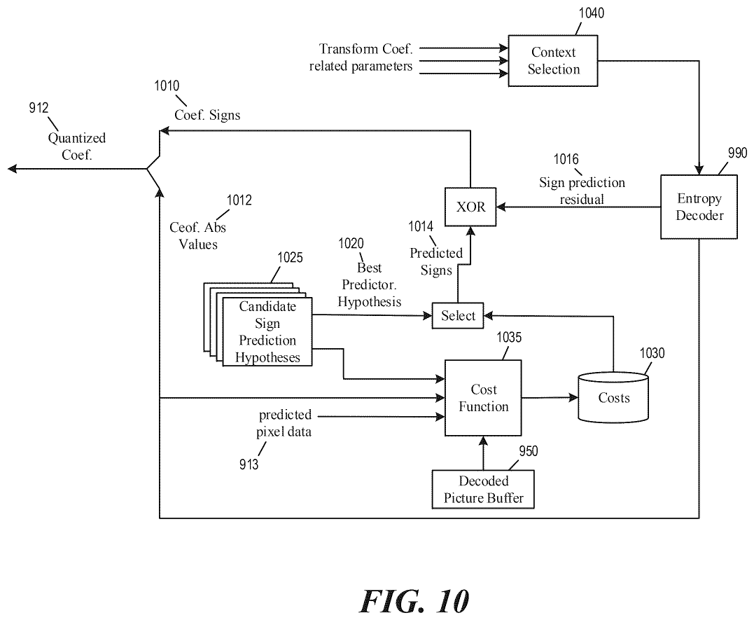

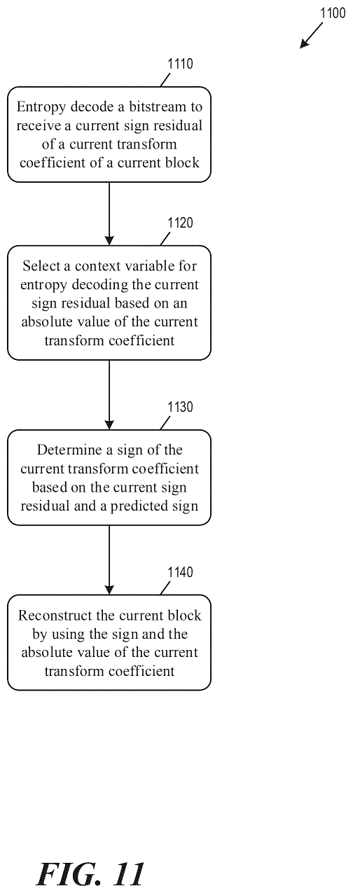

FIG. 10 illustrates portions of the video decoder 900 that implements sign prediction and context selection. As illustrated, the quantized coefficients 912 (from the entropy decoder 990) includes coefficient signs 1010 and coefficient absolute values 1012 components. The sign prediction residuals 1016 (or the actual signs) are XOR′ed with predicted signs 1014 to generate coefficient signs 1010. The predicted signs 1014 are provided by a best prediction hypothesis 1020 which is selected from multiple possible different sign prediction hypotheses 1025 based on costs 1030. The costs 1030 are computed by a cost function 1035 for different candidate sign prediction hypotheses 1025. For each candidate sign prediction hypothesis, the cost function 1035 uses (i) pixel values provided by the reconstructed picture buffer 950, (ii) the absolute values 1012 of transform coefficients, and (iii) the predicted pixel data 913 to compute a cost. In some embodiments, the cost of a particular sign prediction hypothesis may be computed based on residuals in pixel domain that are transformed from a set of transform coefficients having the set of predicted signs of the sign prediction. An example of the cost function is provided by Eqn. (1) and described by reference to FIG. 5 above.

The sign prediction residuals 1016 are provided to the entropy decoder 990 and decoded by an inverse CABAC process. The sign prediction residuals 1016 are coded in the regular mode using one or more context variables or probability models. The context selection (at a context selection module 1040) is based on one or more parameters related to the transform coefficients. The selection of the context variables is described in greater detail in Section II above. In some embodiment, the context selection module 1040 is part of the entropy decoder 990, and the parameters used for the context selection of the sign prediction residuals are parsed from the bitstream 995 by the entropy decoder 990.

FIG. 11 conceptually illustrates a process 1100 for entropy decoding transform coefficients using sign prediction. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder entropy decodes (at block 1110) a bitstream to receive a current sign prediction residual of a current transform coefficient of a current block.

The decoder selects (at block 1120) a context variable for entropy decoding the current sign prediction residual based on an absolute value of the current transform coefficient. The selection of the context variables is described in greater detail in Section II above.

In some embodiments, the context variable is selected dependent on the absolute value of the current transform coefficient when the current transform coefficient belongs to a first set of transform coefficients, or the context variable is selected independent of the absolute value of the current transform coefficient when the current transform coefficient belongs to a second, different set of transform coefficients.

In some embodiments, the context variable is selected dependent on whether the absolute value of the current transform coefficient is greater than a particular threshold or within a particular numerical range. In some embodiments, a first context variable is selected when the transform coefficient is greater than or equal to the particular threshold and a second context variable is selected when the transform coefficient is less than the particular threshold.

In some embodiments, the decoder selects a first context variable for the current sign prediction residual when the current block is coded by using intra-prediction and a second context variable when the current block is coded by using inter-prediction. In some embodiments, the decoder selects a first context variable for the current sign prediction residual when the current transform coefficient belongs to a luma transform block and a second context variable when the current transform coefficient belongs to a chroma transform block.

In some embodiments, the selection of the context variable may be based on a position of the current transform coefficient in a current transform block of the current block. In some embodiments, the selection of the context variable may be further based on at least one of (i) a dimension of the current transform block, (ii) a transform type of the current transform block, (iii) a color component index of the current transform block, (iv) a number of the predicted signs in the current transform block, (v) a number of the non-zero coefficients in the current transform block, (vi) a position of the last significant transform coefficient in the current transform block, (vii) a sum of the absolute values of transform coefficients that are subject to sign prediction, (viii) a sum of the absolute values of the transform coefficients that are subject to sign prediction after the current transform coefficient. In some embodiments, the selection of the context variable may be based on an absolute value of a next transform coefficient that is subject to sign prediction.

In some embodiments, the decoder selects the context variable based on whether the current transform coefficient is a DC coefficient. The selection of the context variable may be based on whether a predicted sign of the DC coefficient of the current block is correct.

In some embodiments, the selection of the context variable is further based on an accumulated number of incorrectly predicted signs in the current block. The decoder may decode the current sign prediction residual into the bitstream in bypass mode when an accumulated number of incorrectly predicted signs of the current block exceeds a threshold.

In some embodiments, the selection of the context variable is based on a total number of sign prediction residuals in the current transform block. In some embodiments, the selection of the context variable is further based on a distance between an origin of the current transform block and a position of the current transform coefficient in the current transform block.

The decoder determines (at block 1130) a sign of the current transform coefficient based on the current sign prediction residual and a predicted sign. In some embodiments, the current sign prediction residual is a difference between a predicted sign and a sign of the current transform coefficient of the current block. In some embodiments, the predicted sign is one of a set of predicted signs of a best sign prediction hypothesis, with the best sign prediction hypothesis being one having a lowest cost among multiple candidate sign prediction hypotheses. The cost of a particular sign prediction hypothesis may be computed based on residuals in pixel domain that are transformed from a set of transform coefficients having the set of predicted signs of the sign prediction hypothesis (e.g., according to Eqn. 1).

The decoder reconstructs (at block 1140) the current block by using the sign and the absolute value of the current transform coefficient. The decoder may then provide the reconstructed current block for display as part of the reconstructed current picture.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

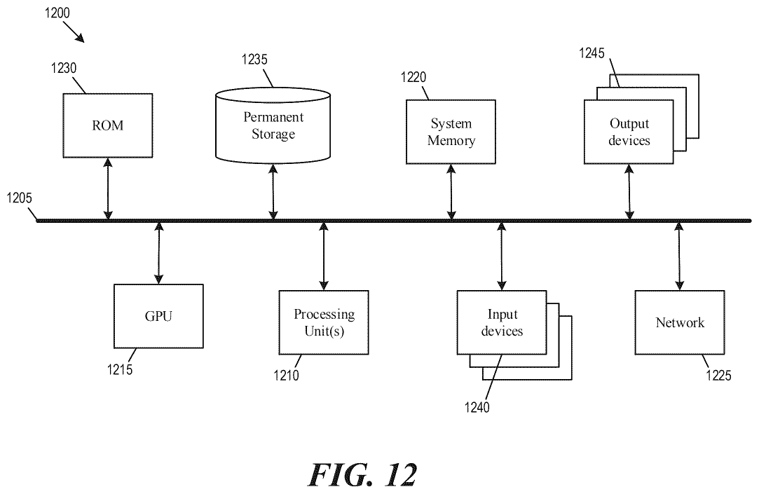

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A video coding method comprising:
receiving data to be encoded or decoded as a current block of a current picture of a video;
selecting a context variable for a current sign prediction residual based on an absolute value of a current transform coefficient, wherein the current sign prediction residual is a difference between a predicted sign and a sign of the current transform coefficient of the current block;
entropy encoding or decoding the current sign prediction residual using the selected context variable; and
reconstructing the current block by using the sign and the absolute value of the current transform coefficient.

2. The video coding method of claim 1, wherein the predicted sign is one of a set of predicted signs of a best sign prediction hypothesis, the best sign prediction hypothesis has a lowest cost among a plurality of candidate sign prediction hypotheses.

3. The video coding method of claim 2, wherein the cost of a particular sign prediction hypothesis is computed based on residuals in pixel domain that are transformed from a set of transform coefficients having the set of predicted signs of the particular sign prediction hypothesis.

4. The video coding method of claim 1, wherein the context variable is selected dependent on the absolute value of the current transform coefficient when the current transform coefficient belongs to a first set of transform coefficients, wherein the context variable is selected independent of the absolute value of the current transform coefficient when the current transform coefficient belongs to a second, different set of transform coefficients.

5. The video coding method of claim 1, wherein the context variable is selected dependent on whether the absolute value of the current transform coefficient is greater than a particular threshold or within a particular numerical range.

6. The video coding method of claim 5, wherein a first context variable is selected when the absolute value of the transform coefficient is greater than or equal to the particular threshold and a second context variable is selected when the absolute value of the transform coefficient is less than the particular threshold.

7. The video coding method of claim 1, wherein selecting the context variable is further dependent on whether the current block is coded by using intra-prediction or by using inter-prediction.

8. The video coding method of claim 1, wherein selecting the context variable is further dependent on whether the current transform coefficient belongs to a luma transform block or to a chroma transform block.

9. The video coding method of claim 1, wherein the selection of the context variable is further based on a position of the current transform coefficient in a current transform block of the current block.

10. The video coding method of claim 1, wherein the selection of the context variable is further based on at least one of (i) a dimension of a transform block that includes the current transform coefficient, (ii) a transform type of the transform block, (iii) a color component index of the transform block, (iv) a number of the predicted signs in the transform block, (v) a number of the non-zero coefficients in the transform block, (vi) a position of the last significant transform coefficient in the transform block, (vii) a sum of the absolute values of transform coefficients that are subject to sign prediction, and (viii) a sum of the absolute values of the transform coefficients that are subject to sign prediction after the current transform coefficient.

11. The video coding method of claim 1, wherein the selection of the context variable is further based on an absolute value of a next transform coefficient that is subject to sign prediction.

12. The video coding method of claim 1, wherein the selection of the context variable is further based on whether the current transform coefficient is a DC coefficient.

13. The video coding method of claim 1, wherein the selection of the context variable is further based on whether a predicted sign of a DC coefficient of the current block is correct.

14. The video coding method of claim 1, wherein the selection of the context variable is further based on an accumulated number of incorrectly predicted signs in the current block.

15. The video coding method of claim 1, wherein the current sign prediction residual is encoded into the bitstream in bypass mode when an accumulated number of incorrectly predicted signs of the current block exceeds a threshold.

16. The video coding method of claim 1, wherein the selection of the context variable is further based on a total number of sign prediction residuals in a current transform block that includes the current transform coefficient.

17. The video coding method of claim 1, wherein the selection of the context variable is further based on a distance between an origin of a current transform block and a position of the current transform coefficient in the current transform block.

18. An electronic apparatus comprising:
a video coding circuit configured to perform operations comprising:
receiving data to be encoded or decoded as a current block of a current picture of a video;
selecting a context variable for a current sign prediction residual based on an absolute value of a current transform coefficient, wherein the current sign prediction residual is a difference between a predicted sign and a sign of the current transform coefficient of the current block;
entropy encoding or decoding the current sign prediction residual using the selected context variable; and
reconstructing the current block by using the sign and the absolute value of the current transform coefficient.

19. (canceled)

20. A video decoding method comprising:
entropy decoding a bitstream to receive a current sign prediction residual of a current transform coefficient of a current block;
selecting a context variable for entropy decoding the current sign prediction residual based on an absolute value of the current transform coefficient;
determining a sign of the current transform coefficient based on the current sign prediction residual and a predicted sign; and
reconstructing the current block by using the sign and the absolute value of the current transform coefficient.
